(19) United States
(12) Patent Application Publication
(10) Pub. No.: US 2011/0192621 A1
(43) Pub. Date: Aug. 11, 2011

(54) Hammer and/or Hammer Drill Having Relubricating Device

(75) Inventors: Helmut Braun, Bergkirchen (DE); Lothar Hentschel, Taufkirchen (DE); Lothar Hentschel, Taufkirchen (DE)

(73) Assignee: Wacker Neuson SE, Munich (DE)

(21) Appl. No.: 13/003,729

(22) PCT Filed: Jul. 7, 2009
(86) PCT No.: PCT/EP2009/004903

§ 371 Date: Feb. 11, 2011

(30) Foreign Application Priority Data
Jul. 11, 2008 (DE) 10 2008 032 791.3

(51) Int. Cl. B25D 17/26; B25D 16/00

(52) U.S. Cl. 173/100

(57) ABSTRACT

The invention relates to a hammer and/or hammer drill acting as a breaker, having a drive, a hammer mechanism driven by the drive, and a crank device disposed in the force flow path between the drive and the hammer mechanism and coupled to an element of the hammer mechanism for transforming a rotary motion of the drive into an oscillating translation motion of the element of the hammer mechanism. A collecting device for collecting lubricant is provided above the hammer mechanism relative to a vertical operating position. The collecting device may be a collecting tank open at the top and defined by a partition of the housing and a separating floor. A connecting rod of the crank device may extend through a cutout in the separating floor. Lubricant collects above the separating floor can be delivered again and again into the interior of the housing by a delivery element.

### BACKGROUND OF THE INVENTION

1. Field of the Invention

The invention relates to a hammer drill and/or jack hammer, in particular a breaker, equipped with a relubricating device.

2. Discussion of the Related Art

Prior-art hammers and/or hammer drills, breakers in particular, are typically operated in a vertical position for an effective impact in an essentially vertical downward direction. The breakers are used for breaking up roadway pavement and concrete slabs but also serve as tie tamping machines. A hammer of that type usually incorporates a drive unit such as a combustion engine and a percussion i.e. hammer mechanism powered by the drive unit.

For converting the rotary movement of the drive into an oscillating translational motion (reciprocating movement) of the hammer mechanism, a wobble-shaft or crank-gear assembly is positioned between the drive and the hammer mechanism. By means of the crank gear, which typically includes a connecting rod, the rotary movement of the drive motor can be converted into the back-and-forth movement of a drive piston in the hammer mechanism. In addition, a transmission gear may be positioned between the drive and the crank gear for reducing the number of revolutions of the motor. A configuration of this type has been known for a long time.

In these hammers, the hammer mechanism, and often the transmission gear as well, are greased using leakage lubrication. At the transition point to a tool holder in which a tool such as a cutting bit is mounted, the hammer mechanism is not sealed, permanently allowing the lubricant to exit at the tool holder. This is by design in that it removes contaminants from the hammer mechanism and lubricates the tool holder. In the case of large pavement breakers, which are always operated in an approximately vertically downward direction, the lubricant, squeezed into the hammer via a grease nipple in the upper section, progressively flows downward and exits the machine via the tool holder while at the same time lubricating the shank of the tool. In a lighter and less expensive design the hammer mechanism and the transmission gear positioned between a drive and the hammer mechanism are housed in a crank case, permitting joint lubrication of the hammer mechanism and the transmission gear. In this case, both the transmission gear and the hammer mechanism are greased using the same lubricant. DE 39 36 849 A1, EP 0 861 997 B1 and DE 101 63 278 A1 all describe regreasing devices each of which is equipped with an added, separate lubricant reservoir. Such separate devices providing calibrated leakage lubrication or separate on-demand leakage lubrication require a more complex engineering effort.

On the other hand, pavement breakers without leakage lubrication, i.e. with a sealed housing, require complex provisions for achieving the necessary degree of tightness. Moreover, they require periodic maintenance and the replacement of the used lubricant and of the worn gaskets.

In the case of leakage lubrication without a separate lubricant reservoir, i.e. without on-demand lubrication, there is a risk in that the lubricant, usually the grease, very rapidly leaks out of the machine. This is due to the fact that, after extended operation, the hammer heats up strongly, causing the grease to become fluid. This results in considerable lubricant consumption, short regreasing intervals and contamination of the environment.

Leakage lubrication of an unsealed hammer mechanism with oil is not possible since the oil does not adhere to the components of the hammer mechanism as well as does grease.

In the case of a lighter, less expensive breaker design the hammer mechanism and the transmission gear are housed in a common space, the result being a relatively long and high crank case compartment. Since the effect of gravity causes the lubricant to flow downward, the transmission gear, usually positioned in the top section i.e. above the hammer mechanism, may encounter a lubricant deficiency. Even sealing the bottom end of the hammer above the tool holder cannot ensure adequate lubrication of the greasing points located farther up.

### SUMMARY OF THE INVENTION

It is the objective of this invention to introduce a hammer and/or hammer drill, in particular a breaker, in which, during its operation, adequate lubrication of the components that need to be greased is ensured, thus extending the lubricating intervals without requiring any significant structural complexity such as the addition of another lubricant reservoir.

According to the invention this objective is achieved with a an implement, such as a hammer and/or hammer drill, comprises a drive, a hammer mechanism that is powered by the drive and that is positioned in a power flow path between the drive and the hammer mechanism, and a crank gear that is positioned in the power flow path between the drive and the hammer mechanism, that is coupled to an element of the hammer mechanism, and that converts a rotary movement of the drive into an oscillating translational movement of the element of the hammer mechanism. A collecting device is provided above the hammer mechanism that collects lubricant.

The element of the hammer mechanism may be a drive element such as a drive piston which, by way of a pneumatic spring, drives a percussion piston in the hammer mechanism in traditional fashion.

The operating position of the hammer and/or hammer drill (hereinafter also referred to simply as the “hammer”) extends in a vertical direction, producing an effectively vertical downward main working direction. Hammers of this type are so large and heavy that they can be operated in an essentially vertical downward direction only. Working at an excessively oblique angle or even upward is in most cases impossible or a rare exception at best.

With the aid of the collecting device (also referred to as the lubricant vessel) it is possible to prevent the lubricant, which was initially present in the area of the crank gear, from dripping down onto the hammer mechanism. At least, the lubricant vessel is to keep an excessive amount of the lubricant from reaching the hammer mechanism. That achieved, there is no need for also sealing the bottom of the hammer mechanism facing a tool holder. Instead, most of the lubricant is to be intercepted and retained by the collecting device above the hammer mechanism.

Accordingly, in the operating position of the hammer the crank gear can be located above the hammer mechanism. The lubricant retained by the collecting device above the hammer mechanism can then be used to durably grease the crank gear.

Specifically, the collecting device can be equipped with an open-top lubricant vessel, allowing the lubricant to easily reach the lubricant reservoir where it is captured. It cannot, or only slowly, pass the collector and reach the hammer mechanism.

Alternatively, the collecting device can be provided with an opening for feeding a specific albeit small amount of lubricant to the hammer mechanism, thus keeping the hammer mechanism greased.

A transmission gear can be positioned in the power flow between the drive and the crank gear. This transmission gear is capable of reducing the relatively high rate of rotation of the motor to a lower operating frequency of the hammer mechanism. In that case, the transmission gear as well can be greased using the lubricant retained in the collecting device.

In the operating position of the hammer, the transmission gear as well can then be positioned above the hammer mechanism.

A delivery device, coupled to the crank gear and/or to the transmission gear, may be incorporated in a manner whereby it delivers the lubricant from the collecting device to the crank gear and/or to the transmission gear. The above-described lubricant vessel serves to prevent an excessive amount of lubricant from reaching the hammer mechanism. Instead, the lubricant is retained and collected in the upper section of the hammer. With the aid of the delivery device the lubricant can be fed from the collecting device to the crank gear and/or to the transmission gear for their necessary lubrication.

Specifically, the delivery device can include a delivery element, attached to the crank gear and/or to the transmission gear, for delivering lubricant from the lubricant vessel. The delivery element is capable of drawing lubricant from the collector and delivering it at least upwards in the direction of the crank gear or the transmission gear. It is not absolutely necessary for the lubricant to be delivered in targeted fashion to individual points of the crank gear or of the transmission gear. Instead, it suffices for the lubricant to be squirted for instance in the upward direction. In the process the lubricant may drip off the walls of a crank-gear or transmission-gear housing, thus randomly coating the areas to be greased. The generally suitable lubricant in this case is oil or grease.

The delivery element may be provided on a component of the crank gear and/or of the transmission gear and, as that component moves during operation, it may cyclically or permanently be immersed in the lubricant reservoir. That obviates the need to provide the delivery element with its own movement mechanism or even a separate drive. Instead, the delivery element can be moved in tandem with the movement of the crank gear or of the transmission gear, dipping into the lubricant reservoir either intermittently as for instance with every rotation, or permanently, delivering i.e. squirting lubricant upward.

The delivery element may be in the form of a porous or poriferous element (such as a sintered wheel), an absorbent element such as a felt disk or felt gear, or an element with a porous, poriferous or absorbent surface (such as a sintered wheel or a metal wheel with a sintered or felt surface), or a scoop-shaped element. The important requirement for the delivery element is its ability to take up the lubricant.

The crank gear can encompass a crank element and a connecting rod. The crank element may consist for instance of a knuckle pin rotating on a wheel and driving the connecting rod in traditional fashion. The knuckle pin is rotated via the drive motor and, if provided, via the interpositioned transmission gear.

Underneath the crank element and above the hammer mechanism the collecting device may be provided with a separating base which may also constitute for instance part of the collecting device. The connecting rod can extend through a cutout in the separating base. Accordingly, a major part of the crank gear is positioned above the separating base and the hammer mechanism is positioned below the separating base. Only the connecting rod extends through the separating base for transferring the drive energy to the hammer mechanism. Even with a cutout provided in the base, the effect of the separating base is such as to cause the lubricant that is initially present in the upper part of the hammer, i.e. in the area of the crank gear and of the transmission gear, to be retained in the upper part. The cutout is so designed that only a relatively small amount of lubricant can reach the hammer mechanism below.

The cutout in the separating base may be surrounded by a raised rim delimiting it from the separating base. That raised rim is an additional means for preventing lubricant from reaching the hammer mechanism through the cutout. In that way the raised rim serves as a sort of non-contact seal for the connecting rod that extends through the cutout.

The collecting device can thus be constituted of the separating base, the rim, as well as the wall of a housing surrounding at least the crank gear. The separating base constitutes the bottom of the vessel while the rim around the cutout (on the inside) and the wall of the housing surrounding at least the crank gear (on the outside) make up its perimeter.

The separating base can be provided with a recess that serves as the lubricant reservoir into which the delivery element can be immersed during its movement. The delivery element can dip into the reservoir either cyclically or it may be permanently immersed in the recess, delivering lubricant out of the recessed reservoir. The recess ensures that even a small amount of lubricant can be used to adequately grease the components that need to be lubricated.

The above thus represents a very simple, robust hammer mechanism that needs to be relubricated at long intervals only and requires no slip seals, snaps or snap gaskets. The hammer mechanism, the crank gear and the transmission gear can be housed in a common crank case, still ensuring adequate lubrication of the top-mounted components—as viewed in the operating position or main direction of the hammer—and in particular of the components of the transmission gear and the crank gear. This configuration can thus be built easily and at low cost while avoiding the danger of insufficient lubrication.

These and other advantages and features of the invention will be explained in more detail below, through examples and with the aid of corresponding figures in which—

### BRIEF DESCRIPTION OF THE DRAWINGS

FIG. 1 is a schematic side view of a breaker in a first embodiment;

FIG. 2 shows the breaker per FIG. 1 in a slightly tilted operating position;

FIG. 3 illustrates a modified embodiment of the breaker; and

FIG. 4 shows yet another variation of the embodiment of a breaker.

### DETAILED DESCRIPTION OF THE PREFERRED EMBODIMENT

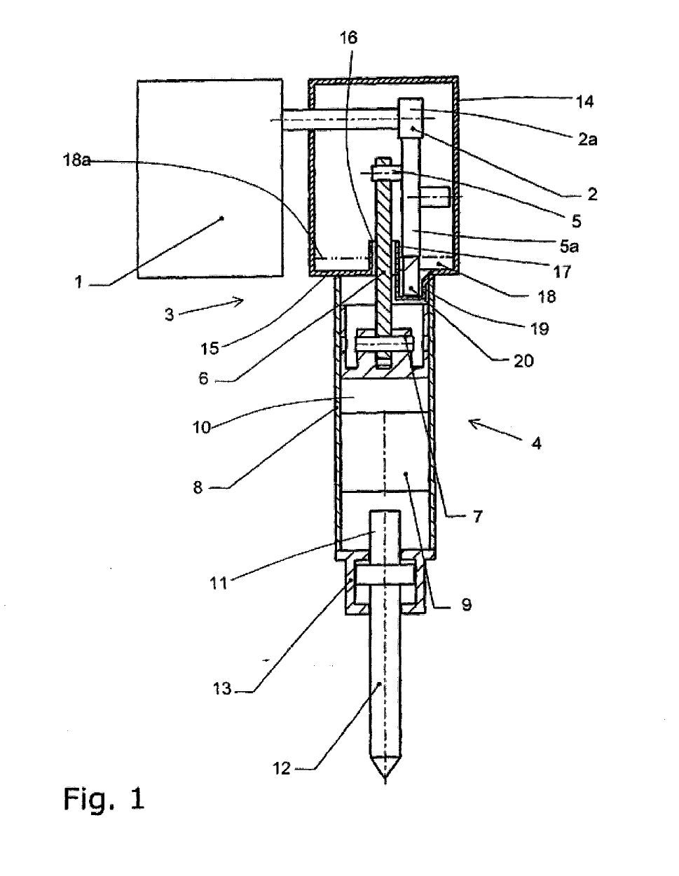

FIG. 1 is a schematic side view of a breaker serving as a hammer and/or hammer drill.

A motor 1 drives a hammer mechanism 4 via a transmission gear 2 and a crank gear 3. Motor 1 may be a combustion engine, a pneumatic engine, a hydraulic engine or an electric motor.

Transmission gear 2 drives a crank disk 5a with a knuckle pin 5 in a rotating motion. By way of a connecting rod 6 the rotary movement of knuckle pin 5 is converted into a linear reciprocating movement which is transferred to a drive piston 7 that is part of hammer mechanism 4. Activated by connecting rod 6, drive cylinder 7 can thus move back and forth in a guide cylinder 8.

Positioned in front of drive piston 7, i.e. below it, is a percussion piston 9 that is part of hammer mechanism 4. The movement of drive piston 7 is transferred to percussion piston 9 via a pneumatic spring 10 formed between drive piston 7 and percussion piston 9, intermittently moving the latter forward (downward) in the main working direction.

Percussion piston 9 on its part cyclically strikes shaft end 11 of a tool in the form of a cutting bit 12 by means of which the desired working result can be achieved. Shaft end 11 is mounted in a tool holder 13.

The upper section of crank gear 3 and of transmission gear 2 is surrounded by a housing 14 from whose bottom side extends guide cylinder 8.

Formed into the bottom of housing 14 is a separating base 15 which separates housing 14 from guide cylinder 8. Located roughly in the center of separating base 15 is a cutout 16 through, which extends connecting rod 6. Cutout 16 is so dimensioned that, during operation, connecting rod 6 can move freely in cutout 16.

Cutout 16 is surrounded by a raised rim 17. Combined, rim 17, separating base 15 and the wall of housing 14 form an open-top collecting vessel in which lubricant 18 can be collected. A broken line 18a in FIG. 1 shows the level of lubricant 18.

Toward one side, separating base 15 is provided with a recess 19 in which the lubricant can accumulate. This is important especially when very little of lubricant 18 is left in housing 14. The residual lubricant can be collected in recess 19.

Extending into recess 19 is a lubricating wheel 20 which is rotated by transmission gear 2 or by crank disk 5a that supports knuckle pin 5. Lubricating wheel 20 may be in the form for instance of a sintered wheel or a felt wheel, or of a synthetic-resin or a metal wheel with a surface of felt or other adsorbent or absorbent material. The adsorbent or absorbent surface takes up lubricant from recess 19 and transfers the lubricant to the active surface of the externally toothed crank disk 5a. This transports lubricant upward so that even pinion 2a of transmission gear 2 can be greased. The high speed of rotation of the gears and other moving elements (knuckle pin 5, connecting rod 6) causes the lubricant to be distributed inside housing 14. Any lubricant that is scattered against the inner wall of housing 14 will flow back down into the collecting vessel above separating base 15, from which it can ultimately be newly retrieved and redelivered.

Only a small amount of the lubricant will pass downward through the gap between connecting rod 6 and cutout 16 to reach hammer mechanism 4. That relatively marginal proportion of the lubricant serves to grease hammer mechanism 4, including among others the inner wall of guide cylinder 8 that constitutes the gliding surface for drive piston 7 and percussion piston 9. It can also serve to grease the pin that links connecting rod 6 and drive piston 7.

Little by little, very slowly and in only minuscule amounts, lubricant will also reach shaft end 11 and, from there, tool holder 13, thus also greasing these elements before the lubricant exits from tool holder 13.

By suitably dimensioning cutout 16, i.e. the gap between cutout 16 and connecting rod 6, it is possible to have the supply of lubricant contained in housing 14 last for a sufficiently long time. Replenishing the lubricant will not be necessary until the next standard maintenance cycle.

Grease is a suitable lubricant, but oil can be used as well since the collecting vessel and in particular the separating base 15 are so configured as to retain much of it in housing 14.

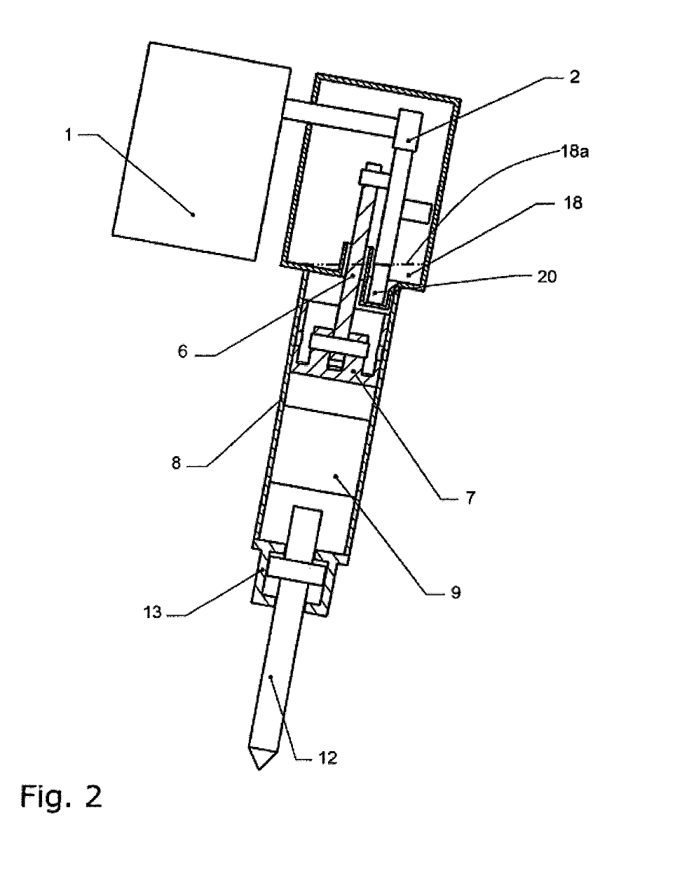

FIG. 2 shows the hammer of FIG. 1 in an operating position which, while slightly tilted away from the vertical line, is still essentially vertical. The corresponding level of lubricant 18 is again indicated by broken line 18a.

It can be seen that lubricating wheel 20 is still sufficiently well immersed in lubricant 18 so that adequate lubrication is ensured even in the tilted hammer position.

The main working direction still points downward. However, the hammer can easily be tilted up to 45° relative to the perpendicular line without risking inadequate lubrication.

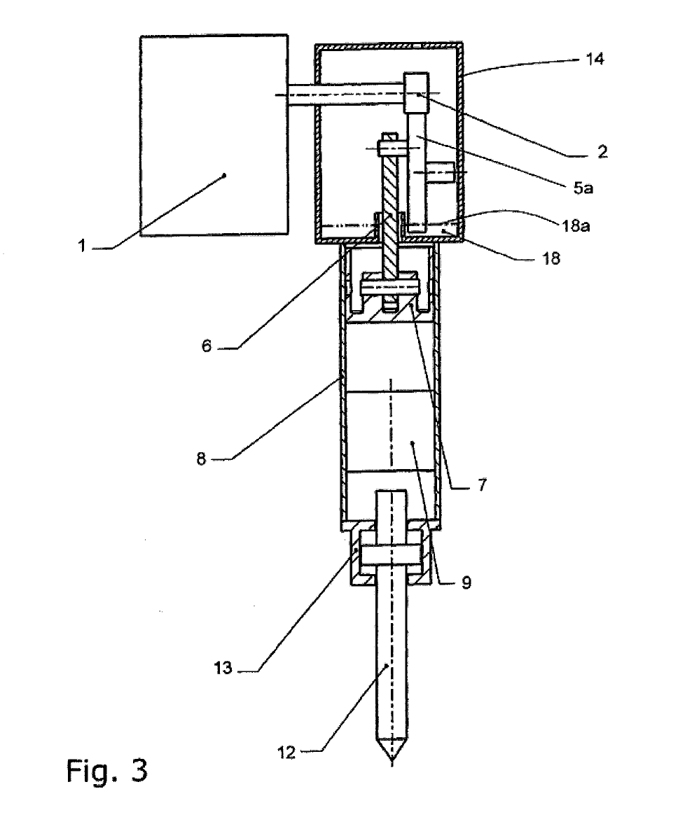

FIG. 3 shows a modified embodiment of the invention.

There it is part of transmission gear 2 itself, or of crank gear 3, that is immersed in lubricant 18. Crank disk 5a is so dimensioned that, with its circumference i.e. its outer teeth, it dips into lubricant 18 and carries lubricant 18 upward. In this case there is no need for an additional delivery element such as lubricating wheel 20 in FIG. 1. The delivery device is now integrated into crank gear 3 or transmission gear 2.

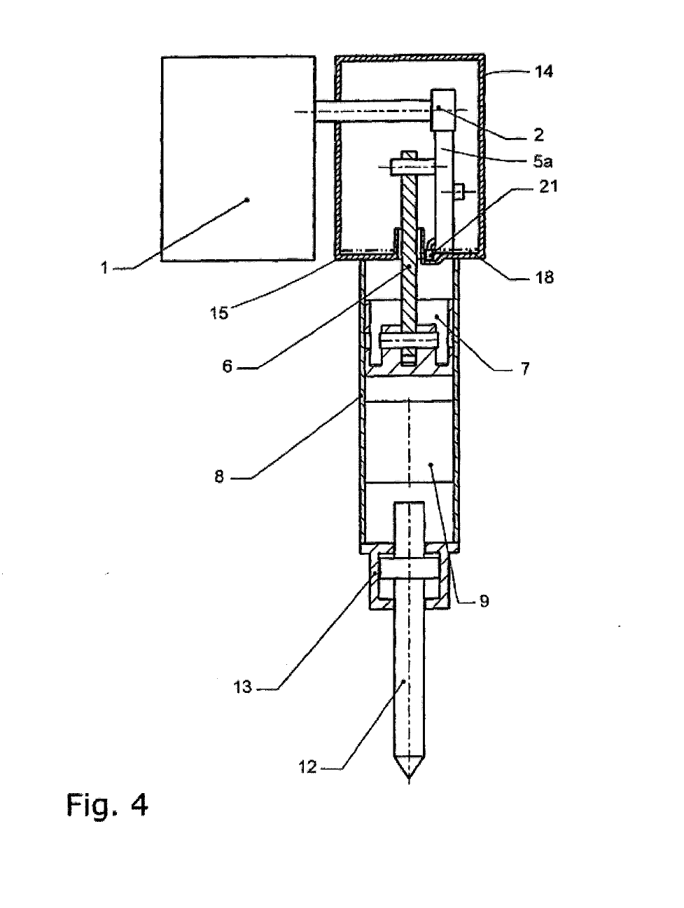

FIG. 4 illustrates yet another variation of the embodiment.

In this variation, crank disk 5a of crank gear 3 is provided with a scoop 21 that serves as the delivery element and is immersed in lubricant 18 with every rotation of crank disk 5a. Scoop 21 may be in the form of a small ladle whereby, with each rotation, lubricant is scooped up from the reservoir contained in separating base 15 and splashed into the interior of housing 14. This as well ensures adequate lubrication of the components that need to be greased.

Of course, there are other possible ways to provide a delivery element for feeding lubricant from the collecting vessel above separating base 15 to different points.

As stated, it is not necessary for the delivery element to constitute an additional component. Instead, an element of transmission gear 2, of crank gear 3 (for instance a lug provided on connecting rod 6) or of hammer mechanism 4 (for instance a cogged wheel, a counterweight etc.), serving as the delivery element, can dip directly into the lubricant sump above separating base 15 and send the lubricant upward.

Lubricant 18 is filled into housing 14 of crank gear 3 above separating base 15 that serves as an intermediate bottom, and collects on separating base 15. Regardless of the position of the hammer, lubricant 18 is largely prevented from flowing farther downward. During operation, the delivery element is immersed in the lubricant sump from where it carries or throws lubricant 18 upward. There it is distributed in the upper crank area and then flows along the housing wall back down to separating base 15.

As depicted in the figures, transmission gear 2 can share the space in the upper crank case (housing 14), but it can also be accommodated in an added, separate space, with only crank gear 3 located above the intermediate bottom i.e. separating base 15.

The seals for the moving parts in the hammer, such as the seal between hammer mechanism 4 and cutting bit 12, do not have to meet particularly stringent requirements. Specifically, inside housing 14 there is no oil column requiring a bottom seal when oil is used as lubricant 18. Nor is there a danger of a sudden, unnoticed oil loss. The controlled exiting of lubricant 18 also removes dirt and abraded particles from hammer mechanism 4. No additional lubricant supply is needed for calibrated lubrication and, therefore, there is no need for an added metering or delivery device with its own drive.

1. An implement, comprising:
a drive;
a hammer mechanism powered by the drive and positioned in a power flow path between the drive and the hammer mechanism,
a crank gear that is positioned in the power flow path between the drive and the hammer mechanism, that is coupled to an element of the hammer mechanism, and that converts a rotary movement of the drive into an oscillating translational movement of the element of the hammer mechanism; wherein,
in relation to an operating position of the implement, a collecting device is provided above the hammer mechanism for collecting lubricant.

2. The implement as recited in claim 1, in which, in relation to the operating position of the implement, the crank gear is located above the hammer mechanism.

3. The implement as recited in claim 1, wherein the collecting device is provided with an open-top collecting vessel for lubricant.

4. The implement as recited in claim 1, wherein a transmission gear is positioned within a power flow path between the drive and the crank gear.

5. The implement as recited in claim 1, wherein an operating position of the implement transmission gear is located above the hammer mechanism.

6. The implement as recited in claim 1, further comprising a lubricant delivery device that is coupled to at least one of the crank gear and the transmission gear and that delivers the lubricant from the collecting device in such a manner that the lubricant reaches said at least one of the crank gear and the transmission gear.

7. The implement as recited in claim 6, wherein the delivery device includes a delivery element that is provided on at least one of the crank gear and the transmission gear and that delivers lubricant from the collecting vessel.

8. The implement as recited in claim 6, wherein the delivery element is capable of delivering the lubricant upward.

9. The implement as recited in claim 7, in which the delivery element is provided on an element of at least one of the crank gear and the transmission gear and is caused by the movement of that element during operation to be cyclically or permanently immersed in the collecting vessel.

10. The implement as recited in claim 7, wherein the delivery element is one of a poriferous element, an absorbent element, an element with a porous, poriferous or absorbent surface, andf a scoop-type element.

11. The implement as recited in claim 1, wherein
the crank gear includes a crank element and a connecting rod;
the collecting device is provided with a separating base underneath the crank element and above hammer mechanism; and
the connecting rod extends through a cutout provided in the separating base.

12. The implement as recited claim 11, wherein the cutout in the separating base is surrounded by a raised rim as a delimitation between the separating base and the cutout.

13. The implement as recited in claim 1, in which the collecting vessel is constituted of the separating base, the rim, and at least a housing wall that surrounds the crank gear.

14. The implement as recited in claim 11, wherein
the separating base is provided with a recess serving as a reservoir for lubricant; and
the delivery element, as it moves, is immersed in the recess.

15. An implement, comprising:
a drive;
a hammer mechanism that is powered by the drive and that is positioned in a power flow path between the drive and the hammer mechanism,
a crank gear that is positioned in the power flow path between the drive and the hammer mechanism, that is coupled to an element of the hammer mechanism, and that converts a rotary movement of the drive into an oscillating translational movement of the element of the hammer mechanism, and
a collecting device that is provided above the hammer mechanism and that collects lubricant.

16. The implement as recited in claim 15, further comprising a lubricant delivery device that is coupled to at least one of the crank gear and the transmission gear and that delivers the lubricant from the collecting device in such a manner that the lubricant reaches said at least one of the crank gear and the transmission gear.

17. The implement as recited in claim 16, wherein the delivery device includes a delivery element that is provided on at least one of the crank gear and the transmission gear and that delivers lubricant from the collecting vessel.

18. The implement as recited in claim 17, wherein the delivery element is capable of delivering the lubricant upward.

19. The implement as recited in claim 17, wherein the delivery element is one of a poriferous element, an absorbent element, an element with a porous, poriferous or absorbent surface, and a scoop-type element.

20. The implement as recited in claim 15, wherein
the crank gear includes a crank element and a connecting rod;
the collecting device includes a separating base located underneath the crank element and above hammer mechanism; and
the connecting rod extends through a cutout provided in the separating base.
